(19) United States
(12) Patent Application Publication
(10) Pub. No.: US 2022/0242642 A1
(43) Pub. Date: Aug. 4, 2022

(54) CONTAINER PROVIDED WITH A CURVED INVERTIBLE DIAPHRAGM

(71) Applicant: SIDEL PARTICIPATIONS, Octeville-sur-mer (FR)

(72) Inventors: Florian GODET, Octeville-sur-mer (FR); Pierrick PROTAIS, Octeville-sur-mer (FR)

(21) Appl. No.: 17/164,311

(22) Filed: Feb. 1, 2021

(51) Int. Cl. B65D 79/00; B65D 1/02; B67C 3/24

(52) U.S. Cl. CPC B65D 79/0081; B65D 1/0276; B67C 2003/226; B65D 2501/0036; B67C 3/24

(57) ABSTRACT

A method for making a container made of a plastic material, provided with a base including a standing ring forming a support flange and a diaphragm extending from the standing ring to a central portion, the diaphragm being capable of standing in an outwardly-inclined position, wherein the diaphragm connects to the standing ring at an outer junction forming an outer articulation of the diaphragm; wherein the diaphragm connects to the central portion at an inner junction forming an inner articulation of the diaphragm; whereby the diaphragm is invertible with respect to the standing ring from the outwardly-inclined position to an inwardly-inclined position; and wherein, in the outwardly-inclined position, the diaphragm has an outer curved portion and an inner curved portion of opposite curvatures.

### CROSS-REFERENCE TO RELATED APPLICATIONS

This application claims priority U.S. application Ser. No. 15/739,253 filed Dec. 22, 2017 which claims priority to International Application No. PCT/EP2016/074837 filed Oct. 17, 2016 and foreign priority to EP Application Nos. 15306750.9 and 150305969.6 filed on Nov. 4, 2015 and Jun. 23, 2015, respectively.

### FIELD OF THE INVENTION

The invention generally relates to the manufacturing of containers, such as bottles, which are produced by blow molding or stretch-blow molding from preforms made of plastic (mostly thermoplastic, e.g. PET) material. More specifically but not exclusively, the invention relates to the processing of hot-fill containers, i.e. containers filled with a hot pourable product (typically a liquid), the term “hot” meaning that the temperature of the product is greater than the glass transition temperature of the material in which the container is made. Typically, hot filling of PET containers (the glass transition temperature of which is of about 80° C.) is conducted with products at a temperature comprised between about 85° C. and about 100° C., typically at 90° C.

### BACKGROUND OF THE INVENTION

Several types of containers are (at least allegedly) specifically manufactured to withstand the mechanical stresses involved by the hot filling and the subsequent changes of internal pressure due to the temperature drop.

It is known to provide the container sidewall with flexible pressure panels, the curvature of which changes to compensate for the change of pressure inside the container, as disclosed in European Patent No. EP 0 784 569 (Continental PET). One main drawback of this type of container, however, is its lack of rigidity once opened. Indeed, the pressure panels tend to bend under the grabbing force of the user, who should hence handle the container with care to avoid unintentional splashes.

It is also known to provide the container with a rigid sidewall and a flexible base including an invertible pressure panel.

In a first technique, the pressure panel is flexible and self adjusts to the changes in pressure inside the container. U.S. Pat. No. 8,444,002 (Graham Packaging) discloses a container, the base of which is provided with a pressure compensating panel having numerous hinges and panels, which progressively yield or yield simultaneously depending on the pressure difference between the inside of the container and the outside of the container. Although such a structure has proved efficient to adapt to the changes in pressure inside the container and to maintain the shape of the container sidewall when the container stands alone, it does not provide the necessary strength to withstand external stresses such as vertical compression stresses undergone by the container when stacked or palletized.

In a second technique, disclosed in U.S. Pat. Appl. No. 2008/0047964 (Denner et al, assigned to CO2PAC), in order to alleviate all or a portion of the vacuum forces within the container, the pressure panel is moved from an outwardly-inclined position to an inwardly-inclined position by a mechanical pusher after the container has been capped and cooled, in order to force the pressure panel into the inwardly-inclined position.

Tests conducted on such a container showed that, once inverted to the inwardly-inclined position, the pressure panel does not maintain its position but tends to sink back under the pressure of the content. In the end, after the content has cooled, the container has lost much rigidity and therefore feels soft when held in hand. When stacking or palletizing the containers, there is a risk for the lower containers to bend under the weight of upper containers, and hence a risk for the whole pallet to collapse.

### SUMMARY OF THE INVENTION

It is an object of the invention to propose a container having greater stability.

It is another object of the invention to propose a container provided with an invertible diaphragm capable of maintaining an inverted position and hence of withstanding high external stresses such as axial compression stresses.

It is therefore provided, in a first aspect, a container made of a plastic material, provided with a base including a standing ring forming a support flange and a diaphragm extending from the standing ring to a central portion, said diaphragm being capable of standing in an outwardly-protruding position, said container defining an inner volume to be filled with a product,

wherein the diaphragm connects to the standing ring at an outer junction forming an outer articulation of the diaphragm with respect to the standing ring;

wherein the diaphragm connects to the central portion at an inner junction forming an inner articulation of the diaphragm with respect to the central portion;

whereby said diaphragm is invertible with respect to the standing ring from the outwardly-protruding position, in which the inner junction extends below the outer junction, to an inwardly-protruding position, in which the inner junction extends above the outer junction;

wherein, in the outwardly-protruding position, the diaphragm has:
an outer portion, which connects to the standing ring and is curved in radial section, said outer portion having a concavity turned outwards with respect to the inner volume of the container, and
an inner portion, which connects to the outer portion and to the central portion and is curved in radial section, said inner portion having a concavity turned inwards with respect to the inner volume of the container.

The outer portion facilitates inversion of the diaphragm, while its inner portion provides rigidity in the inverted position, which prevents the diaphragm from sinking back. Pressure within the container is thereby maintained to a high value, providing high rigidity to the container. The important volume swept by the diaphragm between the outwardly-protruding position and the inwardly-protruding position increases the pressure inside the container to such a level that the loss of pressure due to temperature drop does not affect the rigidity of the container, which may hence be trustingly stacked or palletized.

According to various embodiments, taken either separately or in combination:
the radius, denoted R1, of the outer portion and the outer diameter, denoted D, of the diaphragm at the outer junction are such that:

$$\frac{D}{20} \leq R 1 \leq \frac{D}{4}$$

the radius, denoted R2, of the inner portion and the outer diameter, denoted D, of the diaphragm at the outer junction are such that:

$$\frac{D}{6} \leq R 2 \leq \frac{D}{2}$$

the radius, denoted R1, of the outer portion and the radius, denoted R2, of the inner portion, are such that:

R1≤R2
the outer diameter, denoted D, of the diaphragm at the outer junction, and its inner diameter, denoted d, at the inner junction, are such that:

0.3·D≤d≤0.6·D

d≅0.4·D
the diaphragm has a smooth surface;
a junction point between the outer portion and the inner portion is located above or on a line joining the outer junction and the inner junction.

It is provided, in a second aspect, a method for processing a container as disclosed hereinbefore, by means of a processing unit including:
a container supporting frame including a hollow support ring for engaging a container base,
a pusher movable with respect to the container supporting frame, capable of coming into abutment with the container base through the supporting frame for inverting the diaphragm from its outwardly-protruding position to its inwardly-protruding position,
an actuator for slidingly moving the pusher frontwards towards the container base through the supporting frame, and backwards,
   wherein the pusher has a convex upper end surface facing the inner portion of the diaphragm, said upper end surface extending down to an outer limit having a diameter equal to or greater than an outer diameter of the inner portion of the diaphragm.

According to various embodiments, taken either separately or in combination:
the upper end surface is complementary in shape to the inner portion of the diaphragm in its inwardly-protruding position;
the pusher has a concave peripheral surface surrounding the upper end surface, said peripheral surface facing the outer portion of the diaphragm;
the peripheral surface is complementary in shape to the outer portion of the diaphragm in its inwardly-protruding position;
the standing ring of the container has a frusto-conical inner wall joining the support flange and the diaphragm, and the pusher has a frusto-conical lateral skirt complementary in shape to the inner wall;
the pusher comprises a central apex at least partly complementary to the central portion of the container base.

The above and other objects and advantages of the invention will become apparent from the detailed description of preferred embodiments, considered in conjunction with the accompanying drawings.

### BRIEF DESCRIPTION OF THE DRAWINGS

FIG. 1 is a sectional view showing a container provided with an invertible base diaphragm; this view includes a detail of the base at enlarged scale.

FIG. 2 is a diagrammatic view showing a proper method of construction of the base.

FIG. 3 is a diagrammatic view showing an improper method of construction of the base.

FIG. 4-FIG. 11 are enlarged half sectional views showing the base of the container in different embodiments, both in an outwardly-protruding position of the diaphragm (in continuous line) and in an inwardly-protruding position thereof (in dotted line).

FIG. 12 is a sectional view showing the filled and capped container mounted on a processing unit including a pusher shown in its rest position before inversion of the diaphragm of the container base.

FIG. 13 is an enlarged sectional view according to detail frame XIII of FIG. 12.

FIG. 14 is a sectional view similar to FIG. 12, showing the filled and capped container with its diaphragm in its inwardly-protruding position and the processing unit with the pusher in its active position to illustrate inversion of the diaphragm.

FIG. 15 is an enlarged sectional view according to detail frame XV of FIG. 14.

FIG. 16 is an enlarged sectional view similar to FIG. 13, showing a second embodiment of the pusher in its rest position.

FIG. 17 is an enlarged sectional view similar to FIG. 16, showing the pusher of FIG. 16 in its active position.

FIG. 18 is an enlarged sectional view similar to FIG. 13, showing a third embodiment of the pusher in its rest position.

FIG. 19 is an enlarged sectional view similar to FIG. 18, showing the pusher of FIG. 18 in its active position.

### DETAILED DESCRIPTION

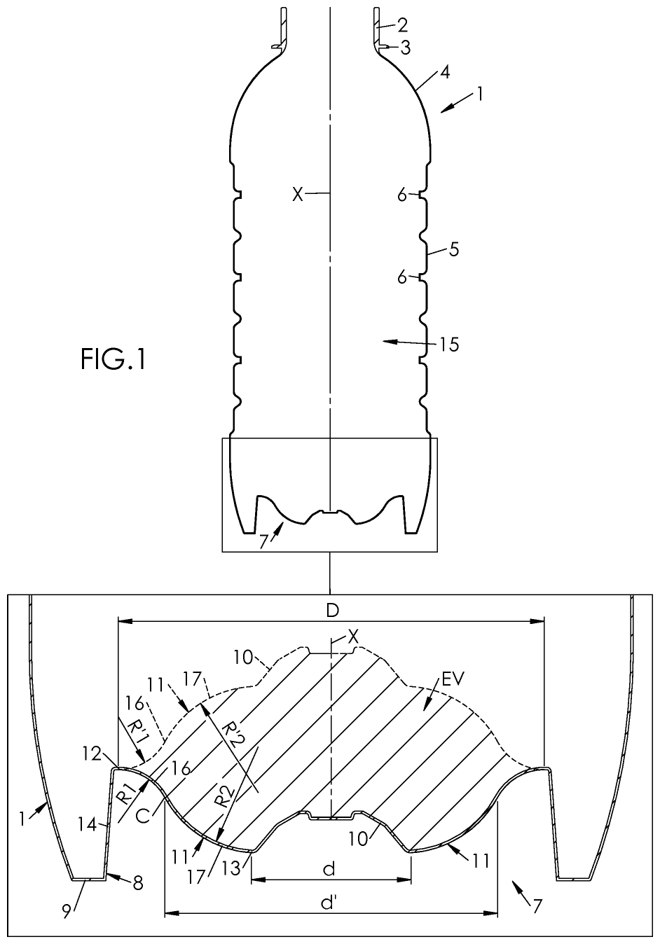

FIG. 1 shows a container 1 suitable for being filled with a hot product (such as tea, fruit juice, or a sports drink), “hot” meaning that the temperature of the product is greater than the glass transition temperature of the material, in which the container 1 is made (about 80° C. in the case of PET).

The container 1 includes an upper open cylindrical threaded upper portion or neck 2, which terminates, at a lower end thereof, in a support collar 3 of greater diameter. Below the collar 3, the container 1 includes a shoulder 4, which is connected to the collar 3 through a cylindrical upper end portion of short length.

Below the shoulder 4, the container 1 has a sidewall 5, which is substantially cylindrical around a container main axis X. The sidewall 5 may, as depicted on FIG. 1, include annular stiffening ribs 6 capable of resisting stresses, which would otherwise tend to make the sidewall 5 oval when viewed in a horizontal section (such a deformation is standard and called ovalization).

At a lower end of the sidewall 5, the container 1 has a base 7, which closes the container 1 and allows it to be put on a planar surface such as a table.

The container base 7 includes a standing ring 8, which forms a support flange 9 extending in a plane substantially perpendicular to the main axis X, a central portion 10 and a diaphragm 11 extending from the standing ring 8 to the central portion 10.

The diaphragm 11 connects to the standing ring 8 at an outer junction 12 and to the central portion 10 at an inner junction 13. Both the outer junction 12 and the inner junction 13 are preferably curved (or rounded). The diaphragm 11 has an inner diameter d, measured on the inner junction 13, and an outer diameter D, measured on the outer junction 12.

The container 1 is blow-molded from a preform made of plastic such as PET (polyethylene terephtalate) including the unchanged neck, a cylindrical wall and a rounded bottom.

In a preferred embodiment depicted on the drawings, the standing ring 8 is a high standing ring, i.e. the standing ring is provided with a frusto-conical inner wall 14 joining the support flange 9 and the diaphragm 11. More precisely, the inner wall 14 has a top end, which forms the outer junction 12 (and hence the outer articulation with the diaphragm 11), whereby in the outwardly-protruding position of the diaphragm 11 the central portion 10 stands above the standing ring 8.

The container 1, which defines an inner volume 15 to be filled with a product, is blow-molded with the diaphragm 11 standing in an outwardly-protruding position, in which the inner junction 13 is located below the outer junction 12 (the container 1 being held normally neck up).

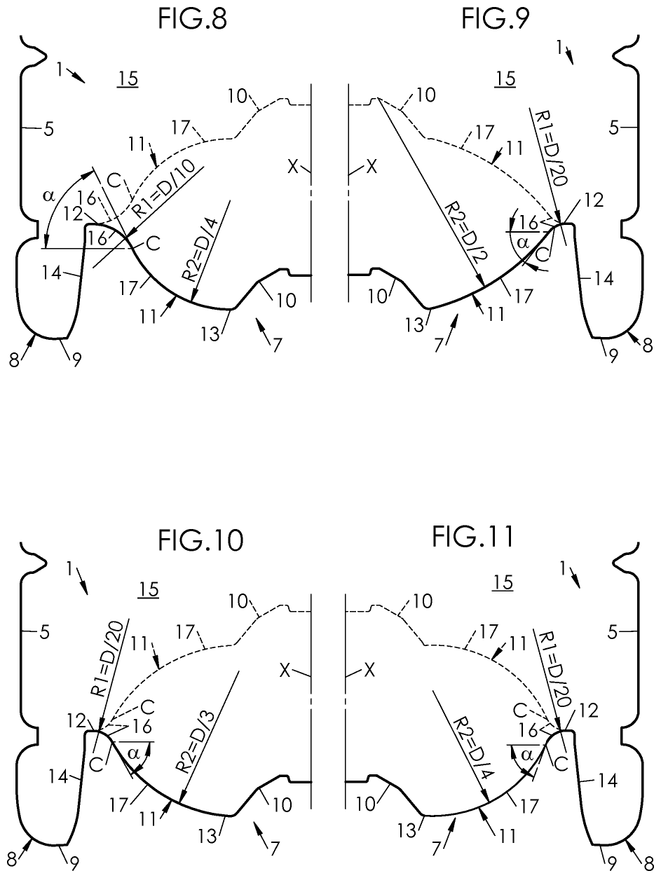

The outer junction 12 forms an outer articulation of the diaphragm 11 with respect to the standing ring 8 (and more precisely with respect to the inner wall 14) and the inner junction 13 forms an inner articulation of the diaphragm 11 with respect to the central portion 10, whereby the diaphragm 11 is invertible with respect to the standing ring 8 from the outwardly-protruding position (in solid line on FIG. 1 and FIG. 4 to FIG. 11) to an inwardly-protruding position wherein the inner junction 13 is located above the outer junction 12 (in dotted lines on FIG. 1 and FIG. 4 to FIG. 11).

Inversion of the diaphragm 11 is preferably achieved mechanically (e.g. with a pusher mounted on a jack, as will be disclosed hereinafter), after the container 1 has been filled with a product, capped and cooled down, in order to compensate for the vacuum generated by the cooling of the product or to increase its internal pressure, and to provide rigidity to the sidewall 5.

Inversion of the diaphragm 11 provokes a liquid displacement (and a subsequent decrease of the inner volume of the container 1) of a volume, which is denoted EV (in hatch lines in the detail of FIG. 1) and called “extraction volume”. The extraction volume EV is comprised between the outwardly-protruding position of the diaphragm 11 and its inwardly-protruding position.

In order to increase the rigidity of the diaphragm 11 and to increase the pressure of the content in the inwardly-protruding position, the diaphragm is provided with a curved outer portion 16 and a curved inner portion 17.

The outer portion 16 connects to an upper end of the inner wall 14 at the outer junction 12 and is curved in radial section. More specifically, when viewed in radial section in the outwardly-protruding position, the outer portion 16 has a concavity turned outwards with respect to the inner volume 15 of the container 1. R1 denotes the radius of the outer portion 16. As depicted on the drawings, at the outer junction 12, the tangent to the outer portion 16 is horizontal (i.e. perpendicular to the axis X).

The inner portion 17 connects to the outer portion 16 and to the central portion 10, and is curved in radial section. More specifically, when viewed in radial section in the outwardly-protruding position, the inner portion 17 has a concavity turned inwards with respect to the inner volume 15 of the container 1, whereby the diaphragm 11 has, in its outwardly-protruding position, a cyma recta (or S) shape. R2 denotes the radius of the inner portion 17. In a preferred embodiment depicted on the drawings, the inner portion 17 is tangent to the outer portion 16.

As illustrated on FIG. 1, diaphragm 11 is such shaped and dimensioned that, in its outwardly-protruding position, the inner junction 13 stands above the plane defined by the standing ring 8.

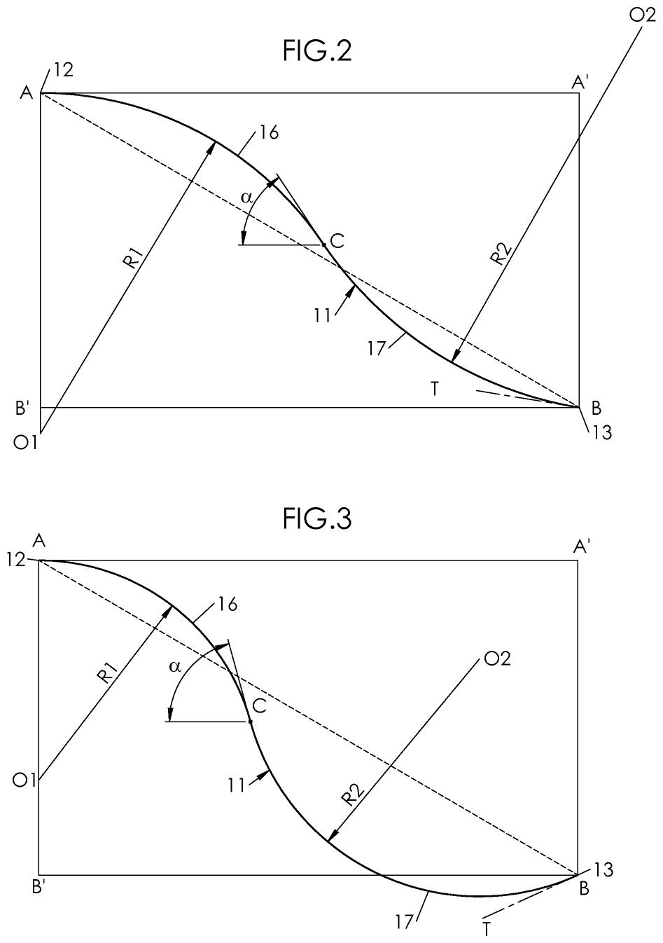

FIG. 2 illustrates a proper geometrical method of construction of the diaphragm 11 in a radial sectional plane. By comparison, FIG. 3 illustrates an improper geometrical method of construction of the diaphragm 11 in a similar radial sectional plane.

In FIG. 2 and FIG. 3, a rectangle AA′BB′ is plotted where A denotes the inner junction 12 and B denotes the inner junction 13. Reference 16 denotes the outer portion of the diaphragm 11, which takes the form or arc of a circle and 17 denotes the inner portion of the diaphragm 11, also in the form of an arc of a circle. Outer portion 16 and inner portion 17 meet at a junction point denoted C, which forms an inflexion point (i.e. a point where curvature of the diaphragm 11 is inverted) between outer portion 16 and inner portion 17. As depicted on FIG. 2 and FIG. 3, the outer portion 16 is tangent to horizontal line (AA′) at point A. In other words, the center of the arc of a circle AC (i.e. of outer portion 16) is located on line (AB′).

Once plotted C and O1, only one arc of a circle (of center denoted O2) can be plotted joining A to C and tangent to (AA′). Then, only one arc of a circle (i.e. inner portion 17) can be plotted joining C to B and tangent to arc of a circle AC (i.e. outer portion 16) at C.

Half line [BT) denotes the tangent to arc of a circle BC with center O2. FIG. 2 illustrates the fact that, when C is located in triangle AA′B, i.e. above diagonal (AB), then the tangent [BT) is located above line (BB′). In other words, the arc of a circle BC (i.e. inner portion 17) is located above the inner junction 13, whereas, on the contrary, FIG. 3 illustrates the fact that, when C is located in triangle ABB′, i.e. below diagonal (AB), then the tangent [BT) is located below line (BB′). In other words, the arc of a circle BC (i.e. inner portion 17) is located below the inner junction 13. The geometry of FIG. 2 should be preferred to build the diaphragm 11 with respect to FIG. 3.

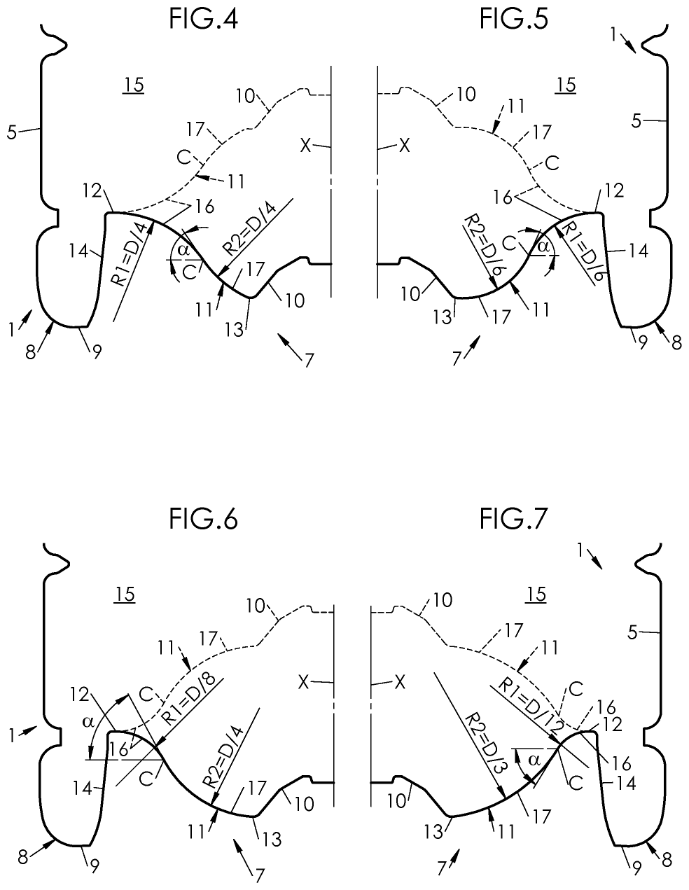

As depicted on FIG. 4 to FIG. 11, the diaphragm 11 has, in its inwardly-protruding position (in dotted lines), a shape that is substantially symmetrical to the shape it has in its outwardly protruding position. In other words, in the upwardly-protruding position, the outer portion 16 has a concavity turned inwards with respect to the inner volume 15 of the container 1, whereas the inner portion 17 has a concavity turned outwards with respect to the inner volume 15 of the container 1. Therefore, choosing the geometry of FIG. 3 wherein the inner portion 17 goes below the inner junction 13 would lead, in the inwardly-protruding position, to a geometry where the inverted inner portion 17 goes above the inverted inner junction 13, whereby the pressure exerted by the content in the vicinity of inner junction 13 has an outwardly-oriented radial component, which might unroll the diaphragm 11 back to its outwardly-protruding position.

By contrast, choosing the geometry of FIG. 2, wherein the inner portion 17 extends above the inner junction 13 leads, in the inwardly-protruding position, to a geometry where the inverted inner portion 17 stands below the inverted inner junction 13, whereby the pressure exerted by the content in the vicinity of the inner junction 13 has only an inwardly-oriented radial component, which provides a locking effect on the diaphragm 11. The geometry of FIG. 2 is therefore preferred to the geometry of FIG. 3.

One can mathematically prove that, as long as the outer portion 16 is tangent to a horizontal line (or plane)—i.e., the arc of a circle AC is tangent to line (AA′), then:
if point C (i.e. the junction between outer portion 16 and inner portion 17) is located within the triangle AA′B, then the inner portion 17 is located above the inner junction 13 (or point B), as depicted on FIG. 2;
if point C (i.e. junction between outer portion 16 and inner portion 17) is located on line (AB), then the inner portion 17 is tangent to the horizontal at point B, i.e. to horizontal line (BB′);
if point C (i.e. junction between outer portion 16 and inner portion 17) is located within the triangle ABB′, then the inner portion 17 partly extends below the inner junction 13 (or point B), as depicted on FIG. 3.

Therefore, in a preferred embodiment, the junction C between outer portion 16 and inner portion 17 is located on or above a line (i.e. line (AB)) joining the outer junction 12 and the inner junction 13.

As depicted on FIGS. 1 and 2, d′ denotes the diameter of the circle centered on axis X and including the junction point C, and α denotes the angle of the tangent to the outer portion 16 (or to inner portion 17) at their junction point C.

The extraction volume EV globally increases with diameter d′ (although other parameters should be taken into account, as will be explained hereinafter). Therefore, d′ should be great enough to maximize the extraction volume EV. More precisely, d′ is preferably greater than half diameter D, and lower than 95% of diameter D:

0.5·D≤d′≤0.75·D

The greater angle α is, the stiffer the diaphragm 11 is in the inwardly-protruding position but the harder it is to invert it from the outwardly-protruding position to the inwardly protruding position.

On the contrary, the lower angle α is, the weaker the diaphragm 11 is in the inwardly-protruding position but the easier it is to invert it from the outwardly-protruding position to the inwardly protruding position.

A good compromise may be found, between good stiffness of the diaphragm 11 in the inwardly protruding position when submitted to the pressure of the container content and good capability of the diaphragm 11 to be inverted from the outwardly-protruding position to the inwardly protruding position, when angle α is comprised between about 55° (which corresponds to the case where point C is located on the line (AB) joining the outer junction 12 and the inner junction 13) and 75°:

560°≤α≤75°

In addition, radius R1 of the outer portion 16 and radius R2 of the inner portion 17 should be chosen with care to maximize the extraction volume EV (i.e. to maximize pressure in the container in the inwardly-protruding position of the diaphragm 11) while providing good inversion capability of the diaphragm 11 and good stiffness thereof in its inwardly-protruding position.

To this end, radiuses R1 and R2 should be selected as follows:

$$\frac{D}{20} \leq R 1 \leq \frac{D}{4} \frac{D}{6} \leq R 2 \leq \frac{D}{2} R 1 \leq R 2$$

Inner diameter d and outer diameter D of the diaphragm 11 are preferably such that:

0.3·D≤d≤0.5·D

In one preferred embodiment:

d≅0.4·D

FIG. 4 to FIG. 11 show various embodiments of the base 7, with respective different geometries of the diaphragm 11, sorted by increasing extraction volume, as shown in the table below, for a container of 0.5 l (other values may apply for container of greater—or smaller—volume). For all those embodiments, D is set equal to 52 mm and d to 19 mm.

| FIG. | R1 (mm) | R2 (mm) | α | d′ (mm) | EV (mm³) |
|---|---|---|---|---|---|
| 4 | 13 (D/4) | 13 (D/4) | 55.6° | 30.4 (0.6 · D) | 17 |
| 5 | 8.67 (D/6) | 8.67 (D/6) | 65.7° | 36 (0.7 · D) | 21.2 |
| 6 | 6.5 (D/8) | 13 (D/4) | 61.5° | 40.4 (0.78 · D) | 22.7 |
| 7 | 4.3 (D/12) | 17.3 (D/3) | 58.4° | 44.4 (0.85 · D) | 24.1 |
| 8 | 5.2 (D/10) | 13 (D/4) | 63.8° | 42.5 (0.82 · D) | 24.2 |
| 9 | 2.6 (D/20) | 26 (D/2) | 51.8° | 47.7 (0.92 · D) | 24.3 |
| 10 | 2.6 (D/20) | 17.3 (D/3) | 60.8° | 47.2 (0.91 · D) | 26.2 |
| 11 | 2.6 (D/20) | 13 (D/4) | 70° | 46.9 (0.9 · D) | 28.4 |

All those embodiments provide greater extraction volume EV than the known solutions, while diaphragm 11 is more or equally rigid in the inwardly-protruding position. While the outer portion 16 serves to facilitate inversion of the diaphragm 11 from the outwardly-protruding position to the inwardly-protruding position, inner portion 17 serves to strengthen the diaphragm 11 in the inwardly-protruding position and prevents it from sinking back to its outwardly-protruding position. Pressure within the container 1 can therefore be maintained at a high value. The container 1 feels rigid when held in hand. In addition, the container 1 provides, when stacked, stability to the pile and, when palletized, stability to the pallet.

As illustrated on the drawings, the diaphragm 11 has a smooth surface (i.e. it is free of ribs or grooves), as the geometry and dimensions described hereinbefore suffice to provide inversion capability and mechanical strength.

As already explained, and as depicted on the drawings, curvatures of the outer portion 16 and inner portion 17 in the inwardly-protruding position of the diaphragm 11 are inverted with respect to the outwardly-inclined position. R′1 and R′2 respectively denote the radius of the outer portion 16 and inner portion 17 in the inwardly-inclined position of the diaphragm 11. As the diaphragm 11 is substantially symmetrical in the inwardly-protruding position with respect of the outwardly-protruding position, the radiuses R1 and R′1 are equal (or substantially equal), and the radiuses R2 and R′2 are also equal (or substantially equal):

R′1≅R1

R′2≅R2

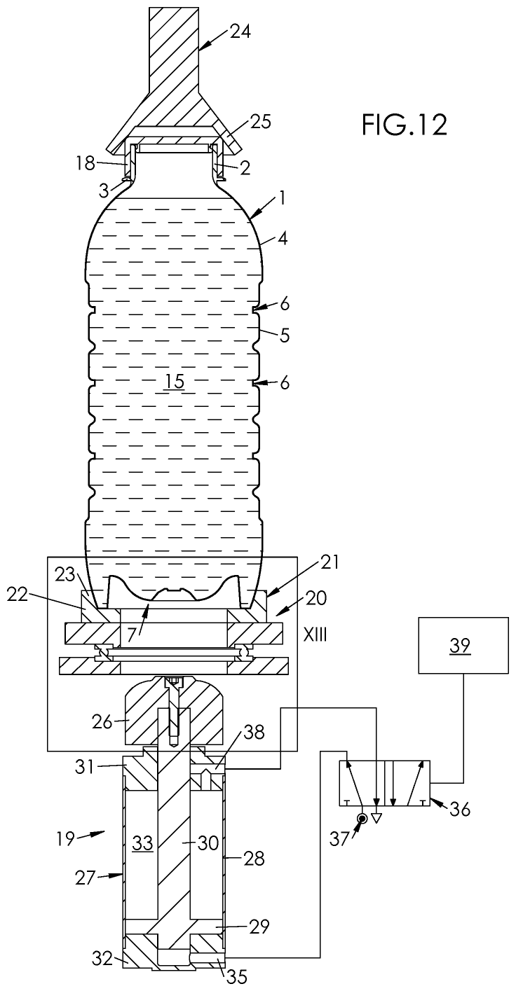

As suggested hereinbefore, inversion of the diaphragm 11 (from its downwardly-protruding position to its upwardly-protruding position) is preferably achieved mechanically (after the container 1 has been filled and closed by a cap 18), e.g. by means of processing unit 19 as illustrated on FIG. 12-19.

The depicted processing unit 19 may be affixed to a carrousel (only partly represented on FIG. 12) rotatably mounted on a fixed support structure, such carrousel including a plurality of identical peripheral processing units 19 displaced along a circular path.

Each processing unit 19 comprises a container supporting frame 20 including a hollow support ring 21 for engaging the container base 7. In the depicted example, the support ring 21 has an annular plate 22 and a tubular outer wall 23, whereby plate 22 and outer wall 23 together form a counter print of at least part of the standing ring 8 of the container base 7.

The supporting frame 20 (and more specifically the plate 22 and outer wall 23) is (are) centered on a main axis, which, when a container 1 is located on the supporting frame 20, merges with the container main axis X. In the following, X denotes both the container main axis and the supporting frame main axis.

The processing unit 19 further includes a container retaining member 24 for rigidly retaining the container 1 in vertical position with its base 7 located within the support ring 21 while the diaphragm 11 is being inverted.

In the depicted example, the retaining member 24 is provided with a conical head 25 suitable for vertically coming into abutment with the cap 18 along the main axis X.

The processing unit 19 further includes a mechanical pusher 26 movable with respect to the supporting frame 20 and capable of coming into abutment with the container base 7 through the supporting frame 20 for inverting the diaphragm 11.

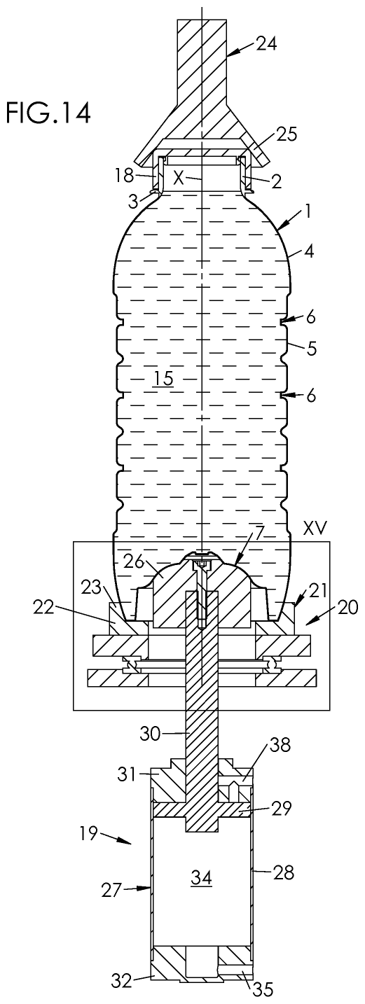

The processing unit 19 further includes an actuator 27 for slidingly moving the pusher 26 along the main axis X, both frontwards (i.e. upwards) towards the container base 7 through the supporting frame 20 to an active position (FIG. 14) in order to achieve inversion of the diaphragm 11, and thereafter backwards (i.e. downwards) to a rest position (FIG. 12), in order for the pusher 26 to be ready for the next inversion cycle.

In the depicted example, it can be seen that the actuator 27 is a hydraulic or pneumatic jack, preferably of the two-way type.

The actuator 27 has a cylinder housing 28, a piston 29 and a rod 30 fixed to the piston 29, with the pusher 26 mounted onto the rod 30. In the depicted example, the pusher 26 is fixed—e.g. by means of one or more screw(s)—to a distal end of the rod 30, but in an alternate embodiment the pusher 26 may be integral with the rod 30.

In a known manner, the actuator 27 has a closure head 31 and a closure bottom 32. The piston 29 defines within the actuator 27 a front chamber 33 around the rod 30 and a back chamber 34 opposite to the rod 30, whereby the front chamber 33 is mainly defined between the piston 29 and the closure head 31, whereas the back chamber 34 is mainly defined between the piston 29 and the closure bottom 32.

As depicted in FIG. 12, the back chamber 34 is in fluidic connection, through a bottom fluid port 35 formed in the closure bottom 32, with a directional control valve (DCV) 36 linked to a source 37 of fluid (such as air or oil) under pressure.

In a preferred embodiment, the front chamber 33 is also in fluidic connection, through a front fluid port 38, to the DCV 36 (which is here of the 5/2 type: 5 ports, 2 spool positions), e.g. through a flow restrictor. This allows for a speed regulation of the piston 29 (and hence of the pusher 26) during actuation, i.e. during inversion of the diaphragm 11. The DCV 36 is preferably driven by a control unit 39, such as a programmable logic controller (PLC).

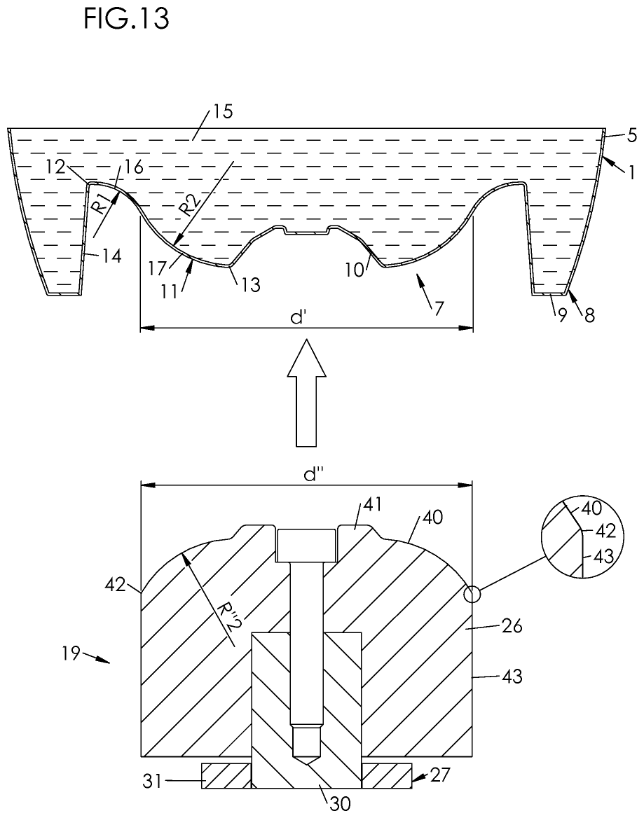

As depicted on FIG. 13, the pusher 26 has a convex upper end surface 40, which faces the inner portion 17 of the diaphragm 11.

The pusher 26 also preferably has a central apex 41, which protrudes outwards (i.e. upwards) axially and is preferably at least partly complementary in shape to the central portion 10 of the container base 7. In the depicted example, the central apex 41 is truncated, whereby it is only partly complementary to a lower peripheral region of the central portion 10. This ensures proper centering of the container base 7 on the pusher 26 during inversion of the diaphragm 11.

The upper end surface 40 is preferably complementary in shape to the inner portion 17 of the diaphragm 11 in its inwardly-protruding position. In other words, the upper end surface 40 has a radius R″2 of curvature, which is equal (or substantially equal) to the radius R′2 of curvature of the inner portion 17 of the diaphragm 11 in the inwardly-protruding position (and hence to the radius R2 of curvature of the inner portion 17 in the outwardly-protruding position). As the radius R′2 may slightly vary depending on the pressure inside the container 1, it should be understood that a slight difference between R″2 and R′2 may exist.

The upper end surface 40 extends from the central apex 41 down to an outer limit 42, which has a diameter d″ equal to or greater than the outer diameter d′ of the inner portion 17 of the diaphragm 11:

d″≥d′

In a first embodiment, the outer limit 42 of the upper end surface 40 is also a peripheral edge of the pusher 26. In this case, the pusher 26 has a cylindrical lateral wall 43, which extends vertically from the outer limit 42. As depicted in the detail view of FIG. 13, the outer limit 42 should preferably not be sharp but instead be provided with a fillet radius to prevent damage to the diaphragm 11 when achieving inversion.

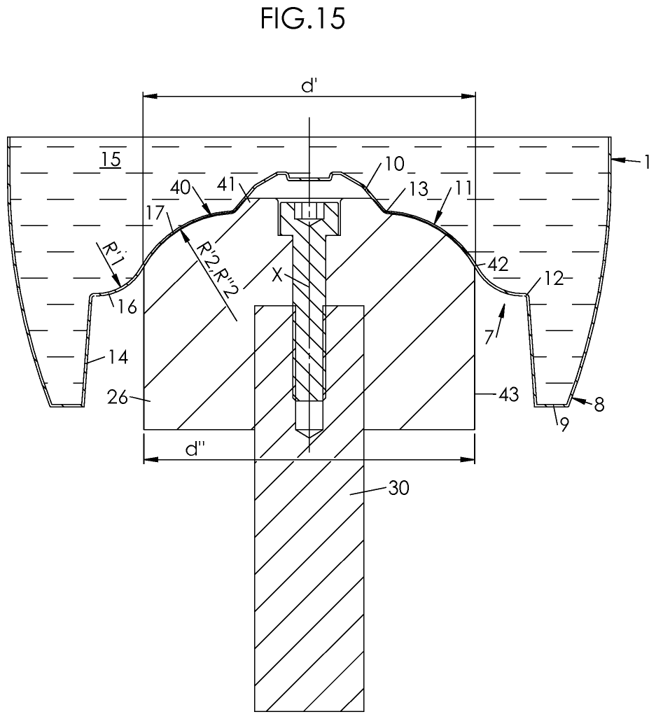

To achieve inversion of the diaphragm 11 from its downwardly-protruding position to its inwardly-protruding position, the pusher 26 (together with the rod 30 and the piston 29) is moved from its rest position, in which the pusher 26 is spaced from the diaphragm 11 (FIG. 12 and FIG. 13) to its active position, in which the pusher 26 protrudes inside the container 1 (FIG. 14 and FIG. 15).

As soon as the pusher 26 comes into abutment against the diaphragm 11, the pusher 26 exerts on the diaphragm 11 an inwardly (or upwardly) oriented inversion effort along the main axis X.

As the pusher 26 moves forwards (i.e. upwards), the inner portion 17 of the diaphragm 11 begins to smoothly (though quickly) wrap around the upper end surface 40 starting from the center (near the apex 41) and finishing with the periphery (near or at the outer limit 42), until the inner portion 17 has reached its inverted position. Moving on, the pusher 26 pulls the outer portion 16 to its inverted position, whereby complete inversion of the diaphragm 11 is achieved (FIG. 15). During the whole inversion process, the apex 41 maintains the container base 7 centered with respect to the pusher 26.

The shape of the upper end surface 40, which is complementary to the inner portion 17 of the diaphragm 11 in its inverted position, provides better control of the inversion of the diaphragm 11 and thereby prevents (or at least reduces) the risk of material cracking. The inversion process is therefore safer and may be accelerated, for the benefits of production rates. The extraction volume (i.e. the volume swept by the container base 7 during inversion) is also maximized.

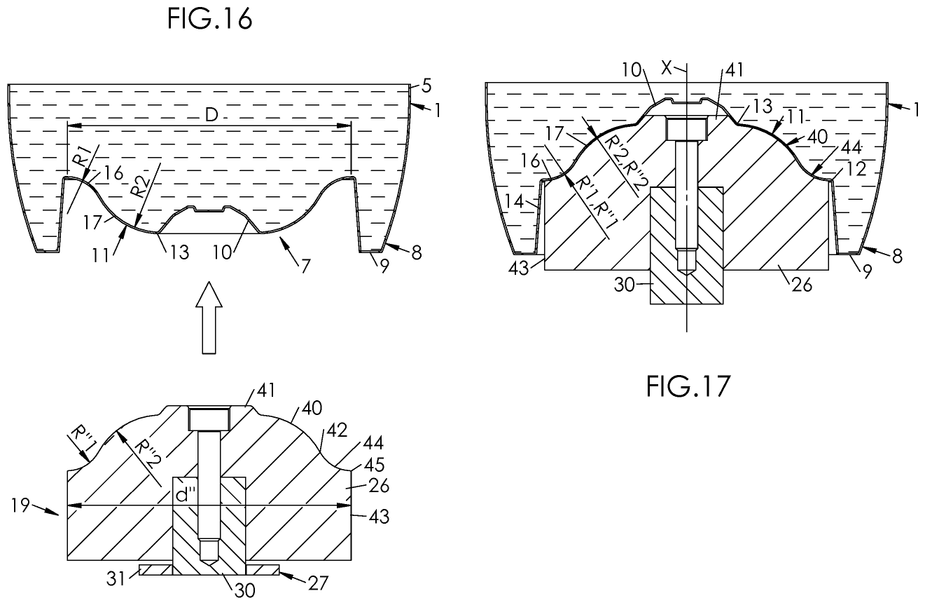

In a second embodiment depicted on FIG. 16 and FIG. 17, having features added to the first embodiment, which has just been disclosed, the pusher 26 further has a concave peripheral surface 44, which surrounds the upper end surface 40 and which faces the outer portion 16 of the diaphragm 11.

The peripheral surface 44 is preferably complementary in shape to the outer portion 16 of the diaphragm 11 in its inwardly-protruding position. In other words, the peripheral surface 44 has a radius R″1 of curvature, which is equal (or substantially equal) to the radius R′1 of curvature of the outer portion 16 of the diaphragm 11 in the inwardly-protruding position (and hence to the radius R1 of curvature of the outer portion 16 in the outwardly-protruding position). As the radius R′1 may slightly vary depending on the pressure inside the container 1, it should be understood that a slight difference between R″1 and R′1 may exist.

In this second embodiment, the peripheral surface 44 extends from the outer limit 42 down to an outer edge 45 (preferably provided with a fillet radius to prevent damage to the diaphragm 11) and the pusher 26 still has a cylindrical lateral wall 43, an outer diameter (noted d″) of which is substantially equal to the outer diameter D of the diaphragm 11.

Inversion of the diaphragm 11 is achieved in the same manner as disclosed hereinbefore. The presence of the peripheral surface 44 provides even greater control of the inversion of the diaphragm 11, the peripheral surface 44 comes into abutment against the outer portion 16 of the diaphragm 11 and hence provides support thereto in its inwardly-protruding position.

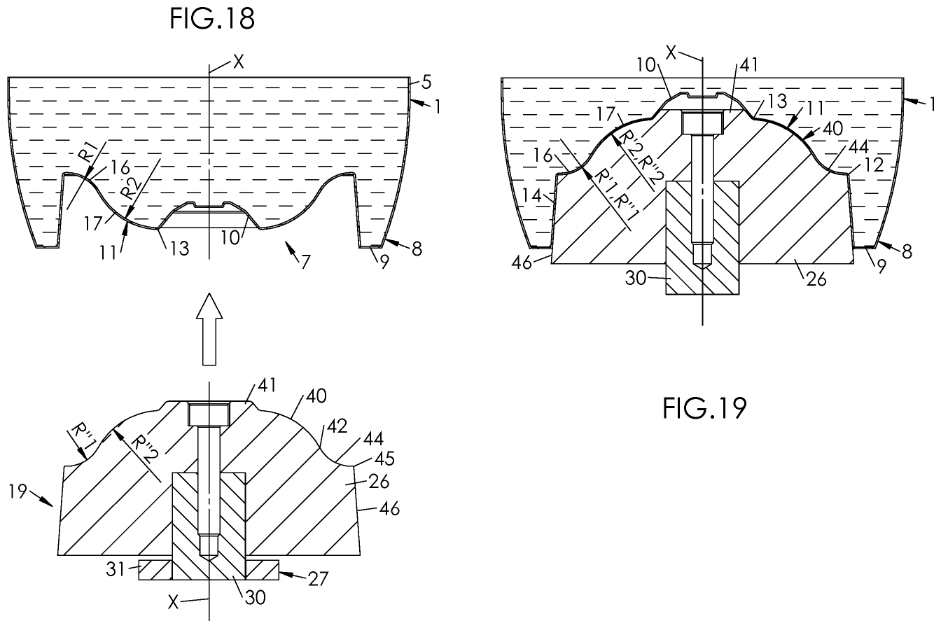

In a third embodiment depicted on FIG. 18 and FIG. 19, having features added to the second embodiment, which has just been disclosed, the pusher 26 further has a frusto-conical lateral skirt 46 (instead of the cylindrical wall 43) complementary in shape to the inner wall 14 and which extends down from the outer edge 45 of the peripheral surface 44. As illustrated on FIG. 19, the lateral skirt 46 comes into abutment with the inner wall 14 in the active position of the pusher 26, whereby the lateral skirt 46 provides stability to the inner wall 14 at the end of the inversion of the diaphragm 11, hence reducing the risk of the diaphragm 11 inverting back to its outwardly-protruding position.

1. A method for processing a container (1) made of a plastic material, the container being provided with a base (7) including a standing ring (8) forming a support flange (9) and a diaphragm (11) extending from the standing ring (8) to a central portion (10), said diaphragm (11) being capable of standing in an outwardly-protruding position, said container (1) defining an inner volume to be filled with a product,
wherein the diaphragm (11) connects to the standing ring (8) at an outer junction (12) forming an outer articulation of the diaphragm (11) with respect to the standing ring (8);
wherein the diaphragm (11) connects to the central portion (10) at an inner junction (13) forming an inner articulation of the diaphragm (11) with respect to the central portion (10);
whereby said diaphragm (11) is invertible with respect to the standing ring (8) from the outwardly-protruding position, in which the inner junction (13) extends below the outer junction (12), to an inwardly-protruding position, in which the inner junction (13) extends above the outer junction (12);
wherein, in the outwardly-protruding position of the diaphragm (11), the central portion (10) stands above the standing ring (8) and the diaphragm (11) has:
an outer portion (16), which connects to the standing ring (8) and is curved in radial section, said outer portion having a concavity turned outwards with respect to the inner volume of the container (1), and
an inner portion (17), which connects to the outer portion (16) and to the central portion (10) and is curved in radial section, said inner portion having a concavity turned inwards with respect to the inner volume of the container (1),
wherein the container (1) is processed by means of a processing unit (19) including including:
a container supporting frame (20) including a hollow support ring (21) for engaging a container base (7),
a pusher (26) movable with respect to the container supporting frame (20), capable of coming into abutment with the container base (7) through the supporting frame (20) for inverting the diaphragm (11) from the outwardly-protruding position to the inwardly-protruding position,
an actuator (27) for slidingly moving the pusher (26) frontwards towards the container base (7) through the supporting frame (20), and backwards,
wherein the pusher (26) has a convex upper end surface (40) facing the inner portion (17) of the diaphragm (11), said upper end surface (40) extending down to an outer limit (42) having a diameter (d″) equal to or greater than an outer diameter (d′) of the inner portion of the diaphragm (11), which outer diameter (d′) is the diameter of the circle centered on axis X and including the junction point (C).

2. The method according to claim 1, wherein the upper end surface (40) is complementary in shape to the inner portion (17) of the diaphragm (11) in the inwardly-protruding position.

3. The method according to claim 1, wherein the pusher (26) has a concave peripheral surface (44) surrounding the upper end surface (40), said peripheral surface facing the outer portion (16) of the diaphragm (11).

4. The method according to claim 3, wherein the peripheral surface (44) is complementary in shape to the outer portion (16) of the diaphragm (11) in the inwardly-protruding position.

5. The method according to claim 3, wherein the standing ring (8) of the container has a frusto-conical inner wall (14) joining the support flange (9) and the diaphragm (11), and wherein the pusher (26) has a frusto-conical lateral skirt (46) complementary in shape to the inner wall (14).

6. The method according to claim 1, wherein the pusher (26) comprises a central apex (41) at least partly complementary to the central portion (10) of the container base (7).

7. The method according to claim 1, wherein the inner portion (17) is tangent to the outer portion (16).

8. The method according to claim 1, wherein the radius, denoted R1, of the outer portion (16) and the outer diameter, denoted D, of the diaphragm at the outer junction (12) are such that:
$$\frac{D}{20} \leq R 1 \leq \frac{D}{4} .$$

9. The method according to claim 1, wherein the radius, denoted R2, of the inner portion (17) and the outer diameter, denoted D, of the diaphragm at the outer junction (12) are such that:
$$\frac{D}{6} \leq R 2 \leq \frac{D}{2} .$$

10. The method according to claim 1, wherein the radius, denoted R1, of the outer portion (16) and the radius, denoted R2, of the inner portion (17), are such that:
R1≤R2.

11. The method according to claim 1, wherein the outer diameter, denoted D, of the diaphragm at the outer junction (12), and its inner diameter, denoted d, at the inner junction (13), are such that:
0.3·D≤d≤0.6·D.

12. The method according to claim 11, wherein
d≅0.4·D.

13. The method according to claim 1, wherein the diaphragm (11) has a smooth surface.

14. The method according to claim 1, wherein a junction point (C) between the outer portion (16) and the inner portion (17) is located above or on a line joining the outer junction (12) and the inner junction (13).
